(19) United States
(12) Patent Application Publication
(10) Pub. No.: US 2007/0267482 A1
(43) Pub. Date: Nov. 22, 2007

(54) Pre-payment for goods and/or services at a point of sale

(75) Inventors: John Ruckart, Atlanta, GA (US); Samuel Zellner, Dunwoody, GA (US)

Correspondence Address: WITHERS & KEYS FOR BELL SOUTH, P. O. BOX 71355, MARIETTA, GA, 30007-1355, US

(73) Assignee: BellSouth Intellectual Property Corporation

(21) Appl. No.: 11/434,696

(22) Filed: May 16, 2006

(51) Int. Cl. G06K 5/00; G06F 17/00

(52) U.S. Cl. 235/380; 235/375

(57) ABSTRACT

Consumers are given the option at the point of sale to make a pre-payment for units of goods and/or services for which the consumer will take possession of at some point in the future. Consumers are given the option at the point of sale to complete a current purchase by utilizing the prepayment for a number of units of goods and/or services that the consumer has previously completed. The prepayment is tracked in terms of the number of units of goods and/or services that have been purchased. The prepayment may be tracked in conjunction with a transactional account such as a credit card account and the consumer may utilize the account such as by swiping a credit card and an option is then provided to either utilize the cash availability of the account to make a purchase based on current pricing or utilize the pre-paid units to make the purchase without regard to current pricing.

### TECHNICAL FIELD

The present invention relates to the sale of goods and/or services. More particularly, the present invention relates to the prepayment for a particular number of units of goods and/or services.

### BACKGROUND

Consumers make purchases of goods and pay for services generally as those goods and services are needed. For example, when an amount of fuel in a vehicle has decreased to a particular point, the driver of the vehicle stops at a fuel station to re-fill the vehicle with fuel. The consumer purchases however many units of fuel it takes for that fuel stop, and the purchase amount is a product of the current price per unit of the fuel and the number of units pumped into the vehicle during that fuel stop.

Such purchases require the consumer to pay the current price per unit of the goods. However, the price per unit of the goods may be volatile, as in the case of fuel. The price of fuel and similar goods may even be highly volatile, changing on a day-to-day or sometimes hour-to-hour basis. Such volatility also exists with regard to services and is problematic for consumers because of the uncertainty of future purchases. Consumers are unable to adequately budget or otherwise prepare for future changes in the prices of such goods.

### SUMMARY

Exemplary embodiments address these issues and others by providing an option to prepay for goods and/or services at the point of sale. The consumer may choose to prepay for units of goods that the consumer cannot currently take possession of so that in the future when the consumer can utilize those units, the consumer exercises the prepaid status in order to purchase and take possession of those units of goods. The consumer may thereby purchase a number of units of goods that are expected to be needed-over a given period of time thereby allowing the consumer to have certainty regarding what the necessary goods for the period of time are costing. Furthermore, the consumer may attempt such a prepayment at a time when the consumer believes the price is favorable in order to receive a savings in the total expenditure relative to what would be paid over time had prepayment not occurred.

According to one embodiment, a system is provided in order to provide pre-paid purchases at a point of sale. The system includes a memory that stores a current pre-pay price per unit of goods and/or services to be purchased in the future. The system further includes a communication system that queries whether a consumer wishes to pre-pay for a future purchase of a given number of units of the goods and/or services at the current pre-pay price and that receives a response to the query, wherein the response comprises a number of units. Additionally, the system includes a database that maintains an account for the consumer by associating an account identifier to the number of units of the goods and/or services for which the consumer has pre-paid.

According to another embodiment, a computer readable medium is provided that contains instructions for providing prepaid sales of units of goods and/or services, wherein execution of the instructions performs various acts including presenting an offer to a customer via an output device to pre-pay for a number of units of goods and/or services. The acts further include receiving via an input device a number of units of goods and/or services to pre-pay, receiving payment from the customer for a price of the number of units of goods and/or services to pre-pay, and storing the number of units of goods and/or services that have been pre-paid in a memory device in association with an identifier for the customer.

According to another embodiment, a method is provided in order to provide for pre-payment of units of goods and/or services. It is detected that the consumer is making a purchase of at least one unit of the goods and/or services after having pre-paid for at least one unit of the goods and/or services, and in response to detecting that the consumer is making the purchase after having pre-paid, an offer is presented to apply the units that have been pre-paid to pay for the purchase. The number of units of goods and/or services being tracked is reduced as needed to pay for the purchase in response to the consumer opting to apply the units that have been pre-paid.

### DESCRIPTION OF THE DRAWINGS

FIG. 1 shows one example of a scenario whereby pre-payment may be offered for units of goods and/or services based on a futures price being secured.

FIG. 2 shows one example of a system that provides for the offer to pre-pay for units of goods and/or services in addition to a current purchase and the offer to utilize a pre-payment for a current purchase.

FIG. 3 shows one example of an operational flow of the system of FIG. 2 when presenting an offer to pre-pay in addition to a current purchase and when presenting an offer to utilize a pre-payment for a current purchase.

FIG. 4A shows an example of a screen display for presenting an option to a user to pre-pay for a particular number of units of goods and/or services.

FIG. 4B shows an example of a screen display for presenting an option to a user to utilize a pre-payment for a current purchase.

FIG. 5 shows an example of a transactional account statement where the transactional account tracks both cash based transactions and pre-paid unit transactions.

### DETAILED DESCRIPTION

Exemplary embodiments provide for the pre-payment for units of goods and/or services. For ease of explanation, much of the description below is directed to the prepayment for units of goods. However, it should be appreciated that the invention is not limited in this way but may also be applicable to the prepayment for services. Consumers may pay for a particular number of units at a time prior to when possession is taken of the goods (or, in the case of services, prior to when the service is performed), such as when purchasing and taking possession of a first set of units of the goods. At a later time when the consumer intends to take possession of some number of units of the goods (or, in the case of services, have the services performed), the number of pre-paid units may be applied so that the consumer may avoid paying the going rate for the goods at that later time.

In the pre-pay context, the most likely situation is for goods with a highly volatile price, e.g., with a week-to-week or even day-to-day volatility, albeit the present disclosure is not limited to such high volatility. However, in the high volatility situation, the consumer is unable to adequately budget or otherwise prepare for future purchases because the price to pay in the future for the goods is uncertain. Because in these situations the consumer is unable to purchase large amounts of these goods with a high price volatility all at once, due to lack of supply, lack of storage, or lack of longevity of the goods, the consumer purchases primarily only that which is needed at the present time.

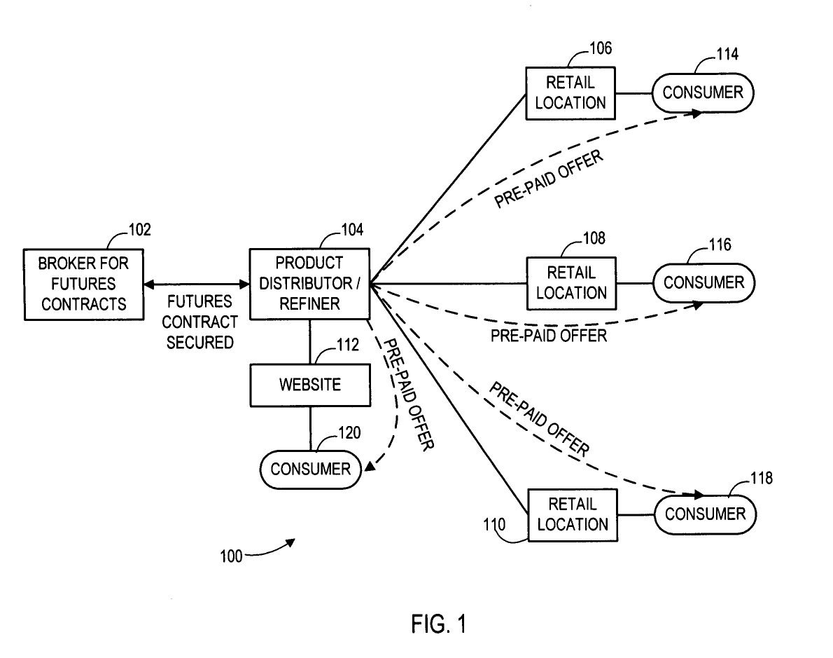

In order to provide a pre-pay option for consumers where the goods have a highly volatile price, the very situation where the pre-pay option is most desirable to consumers, the entity selling the goods on the pre-paid basis will likely prefer to overcome the uncertainty of the goods. FIG. 1 shows one example of an environment 100 where the entity selling the goods on the pre-paid basis does so by first securing a futures contract for the goods, where the futures contract provides a price for a given number of units over a given period of time.

The entity 104 sells the goods on a pre-paid basis. This entity 104 may be a manufacturer (e.g., refiner in the fuel industry), distributor, retailer, or other entity operating within the supply chain. This entity 104 negotiates with a broker 102, such as the mercantile exchange, for futures contracts for the particular goods for which the pre-pay option will be offered to consumers. The entity 104 and the broker 102 reach an agreement as to the number of units to be purchased over a future period of time and the price for which those units will be purchased, and this agreement is reflected in a futures contract.

Once the entity 104 has some degree of certainty regarding the price of the goods over the future period, the entity 104 may then begin to offer pre-payment options to consumers at the point of sale, such as via a website 112 where the consumer ordinarily purchases the goods or at brick and mortar retail locations 106, 108, 110 where the goods are offered for sale. Consumers 114, 116, 118, and 120 visit the points of sale 106, 108, 110, and 112 where they are able to purchase units of the goods, and these consumers are presented with an offer to pre-pay for units of the goods. Furthermore, where consumers 114, 116, 118, and 120 are currently taking possession of the goods from the point of sale, the consumers 114, 116, 118, and 120, if the consumer has previously pre-paid for units of the goods then the consumer is presented with an option to apply the pre-paid units to the current purchase.

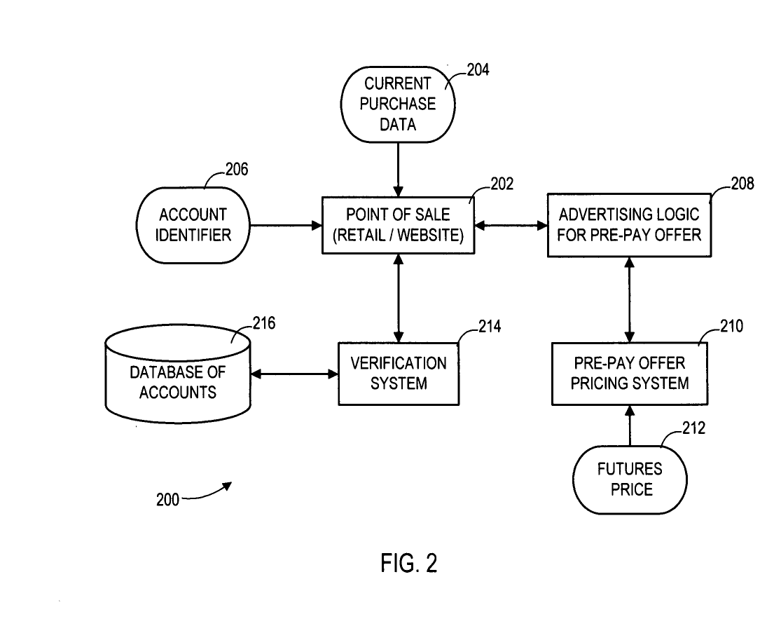

FIG. 2 shows an example of a system 200 for providing the pre-payment option to consumers via a point of sale. In this particular exemplary embodiment, a point of sale 202 such as one of those discussed in relation to FIG. 1 receives information regarding a purchase by a consumer. The point of sale 202 may be a computer system that completes sales transactions, such as a dedicated computer system (e.g., a computerized cash register or computerized fuel pump) or a general-purpose computer system programmed to perform operations to complete the sales transactions.

The point of sale 202 may receive current purchase data 204 that includes the items that the consumer is currently purchasing. This information may be received in the normal manner. For example, a bar code may be scanned for a unit of a good that includes a bar code on the package. As another example, the consumer may access a particular number of units of an unpackaged good such as by pumping a particular number of gallons of fuel. The point of sale 202 is programmed with a current purchase price which applies to the current purchase unless the consumer has available pre-paid credit.

The point of sale 202 may also receive an account identifier data 206 which identifies a transactional account of the consumer that will be used to pay for the current purchase. The transactional account corresponding to the account identifier may be a credit account, a debit account, a credit or debit account that also tracks a balance of pre-paid units, or a dedicated pre-paid account. The transactional account identifier data 206 may be presented to the point of sale 202 such as by the consumer manually entering the account identifier via a keypad or keyboard or by swiping a card in a card reader.

The point of sale 202 also has access to pre-payment sources of information. One or more of the pre-payment sources may include those that specify the current pre-pay price for one or more types of goods, such as a pre-pay price that is based at least on a futures price that has been previously secured. One or more of the pre-payment sources may specify the number of units for which the consumer has pre-paid and has available for application to the current purchase based on the account identifier.

In this exemplary embodiment, the current pre-pay price is offered to the consumer via the point of sale 202 by the point of sale 202 implementing an advertising logic 208. The advertising logic 208 determines the particular pre-pay offer to make to the current customer. For example, the advertising logic 208 may base the pre-pay offer to the current customer based on which goods the customer is currently purchasing. As a specific example, if a consumer is purchasing a premium grade of fuel, the advertising logic 208 may then present an offer to the customer to purchase additional pre-paid units of premium fuel at a current pre-pay price.

In order for the advertising logic 208 to offer the current pre-pay price, upon the advertising logic 208 determining which goods that the pre-pay offer will apply, the advertising logic 208 may then communicate with a pre-pay offer pricing system 210. The pre-pay offer pricing system 210 may provide a base pre-pay price to the advertising logic 208 where the base pre-pay price is a function of the futures price represented by futures price data 212 which has been programmed into the pricing system 210. The base pre-pay price may be determined based on the futures price as well as any mark-up that the entity offering the pre-pay option determines is necessary to achieve a desired profit on the pre-pay sales. Factors in the mark-up may include the additional costs that will be incurred in bringing the goods to market, any discount in the normal mark-up that may be desired so as to make the pre-pay price as attractive as possible to consumers, or any excess mark-up that may be possible for the benefit of pre-payment being offered to the consumer.

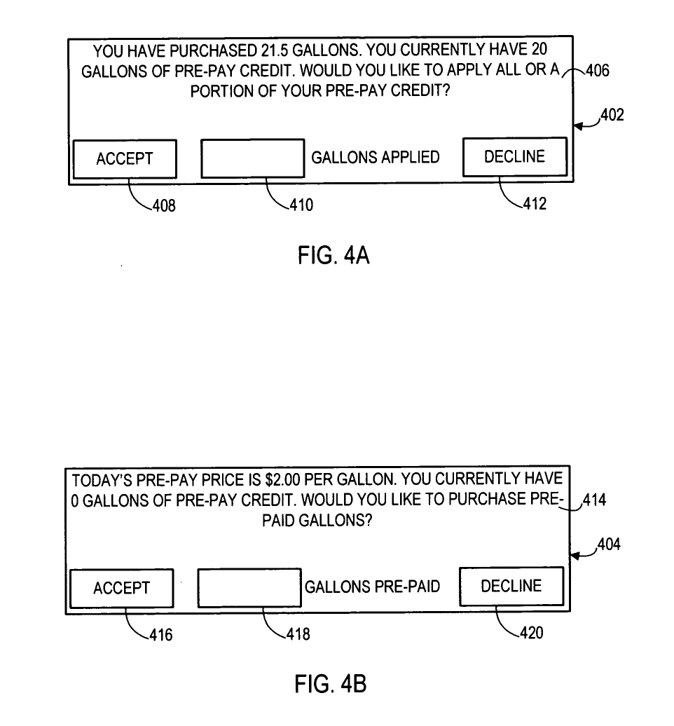

The advertising logic 208 and/or the pricing system 210 may apply additional factors when coming to the current pre-pay price for the current consumer making the current purchase. The current pre-pay price may be a function of the current consumer's purchase history (e.g., buy more over time, get better pre-pay prices) and/or the amount of the current purchase (e.g., buy more now, get a better pre-pay price now). Upon determining the current pre-pay price to be presented for this current purchaser, the advertising logic 208 then provides that pre-pay price in the form of an offer to the consumer via a display of the point of sale 202. Such a display is discussed in more detail below with reference to FIG. 4B.

In this exemplary embodiment, the consumer is also offered the option to apply pre-paid units that the customer has already purchased to the current purchase of goods rather than purchasing the current goods entirely as a cash-based transaction. To do so, the point of sale 202 queries a verification system 214 for information regarding the account represented by the account identifier data 206. The verification system 214 may perform various security checks, such as requiring the consumer to manually enter certain extra digits to better ensure that the consumer presenting the account is likely the true account holder. The verification system 214 accesses an account database 216 that stores account information for a potential multitude of consumer account holders.

The database 216 stores the number of units of goods for which the consumer has already pre-paid at some point in the past. The account identifier may be associated with only one entity and only one type of good. For example, the account may be a fuel account for one brand of fuel. As another example, the account identifier may be for a credit or debit account that includes a cash transaction registry as well as a pre-paid unit's transaction registry. Upon the verification system 214 finding the number of pre-paid units for the goods of interest, i.e., the goods of the current purchase, then the number is returned to the point of sale where the option to utilize all or a portion of those pre-paid units may be display to the consumer. Such a display is discussed in more detail below with reference to FIG. 4A.

The point of sale 202, advertising logic 208, pricing system 210, and verification system 212 may all be implemented as distinct computing systems interconnected via private or public networks. Alternatively, these systems may be combined within a single computing system. In either case, the computing system(s) perform operations in accordance with instructions contained within a computer readable medium, such as instructions encoded on magnetic, optical, or electronic memory and/or as instructions that are propagated signals within wired or wireless connections.

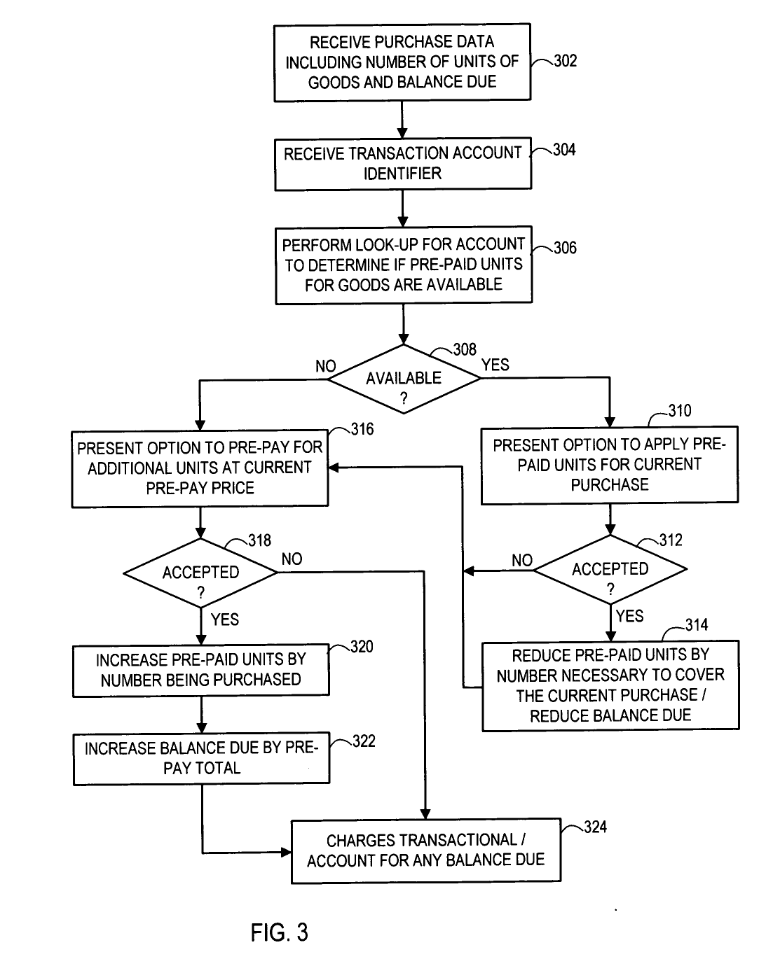

FIG. 3 shows the logical operations performed by the point of sale system according to one exemplary embodiment. Initially, at purchase operation 302, the point of sale system receives the purchase data including the number of units of goods to be taken possession of at the present time and the monetary balance due for that number of units. Thereafter, at account operation 304, the point of sale system receives the account identifier from the consumer regarding the account to be used to pay for the purchase in a monetary and/or pre-pay transaction.

Upon obtaining the purchase and account data, the point of sale system then queries the verification system to perform the look-up of the account to determine whether pre-paid units for the goods are available at look-up operation 306. At query operation 308, it is determined whether the response from the verification system indicated that pre-paid units are or are not available. If pre-paid units are available, then operational flow continues to option operation 310. Otherwise, operational flow continues to option operation 316.

At option operation 310, the point of sale presents the option to the consumer to apply pre-paid units for the current purchase. FIG. 4A shows one example of the display generated at the point of sale. As can be seen in this example, the display 402 includes a textual explanation 406, a button 408 to accept, a field 410 where the number of pre-paid units to apply may be entered such as via a keypad, and a button 412 to decline. At query operation 312, it is detected whether the consumer has elected to accept or decline the option. If the user has declined, then operational flow continues to option operation 316. However, if the user has accepted, then at reduction operation 314 the number of pre-paid units of the database is reduced by the number necessary to cover the current purchase, or by the number specified by the consumer if the consumer entered a number in the field 410. The monetary balance due is reduced based on the number of pre-paid units reducing the number of units for which a monetary transaction is still necessary. Where a sufficient number of pre-paid units are available to cover the entire number of units included in the current purchase, then the balance attributable to the units being purchased goes to zero.

At option operation 316, the point of sale presents the option to the consumer to make a purchase of additional pre-paid units. FIG. 4B shows one example of the display generated at the point of sale. As can be seen in this example, the display 404 includes a textual explanation 414, a button 416 to accept, a field 418 where the number of pre-paid units to be purchased may be entered such as via a keypad, and a button 420 to decline. At query operation 318, it is detected whether the consumer has elected to accept or decline the option. If the user has declined, then operational flow continued to charge operation 324 where the transactional account of the consumer is charged for any balance remaining at this point. If the user has accepted, then at purchase operation 320 the number of pre-paid units is increased in the database for the particular goods. At balance operation 322, the balance due is increased by the monetary amount necessary to pay for the number of pre-paid units being purchased, which is the product of the current pre-pay price and the number of pre-paid units being purchased. Operational flow then proceeds to charge operation 324 where the updated balance due is charged to the transactional account of the consumer.

The exemplary embodiment discussed above for FIG. 3 covers the scenario where the transactional account that is presented provides access to the pre-paid units for the consumer and also provides access to the account used for cash-tracked transactions (i.e., purchases made by monetary credit or debit). It will be appreciated that for instances where the transactional account that is presented is only for the pre-paid units, then when a monetary balance due remains at charge operation 324, the point of sale may prompt the consumer to provide a form of payment such as a credit or debit account or cash. Furthermore, it will be appreciated that for instances where the consumer presents an account identifier that is only for cash-tracked transactions, the point of sale may either proceed without presenting either option or may prompt the consumer to also provide an account identifier for a pre-paid unit transactional account so that either or both options may be presented.

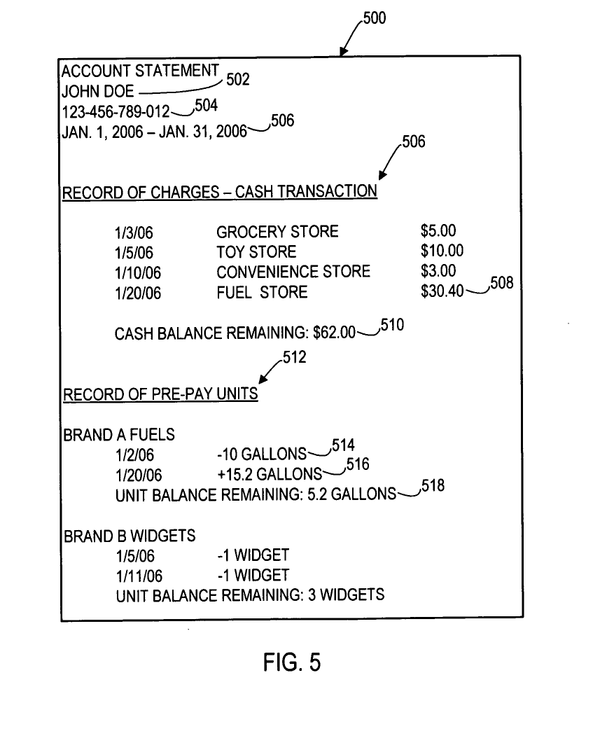

FIG. 5 shows an example of an account statement 500 for a cash-tracked transactional account that also tracks pre-paid unit transactions. The account statement 500 is a reflection of activity that has occurred at the database for the account. This exemplary statement 500 includes the account holder name 502, the account identifier 504, and the period of activity 506. Additionally, the statement 500 is broken down into two sections, a cash transaction section 506 and a pre-paid units section 512.

The cash transaction section 506 is a normal listing of cash tracked transactions. Of particular interest, the cash tracked transaction 508 shows that the consumer has made a $30.40 purchase at the “Fuel Store.” As noted below, this cash tracked transaction 508 was a purchase of pre-paid units. The cash transaction section 506 may also include a line item 510 showing the remaining balance, such as an available credit line balance.

The pre-paid units section 512 of this exemplary embodiment includes a breakdown by selling entities. As shown, item 514 shows that 10 gallons of fuel were obtained on the noted day, as the transaction was for a negative 10 gallons. Item 516 shows that 15.2 gallons were pre-paid on the noted day, as the transaction was for a positive 15.2 gallons. Item 516 of the pre-paid section 512 corresponds to the item 508 of the cash transaction section 506. The item 518 shows that the remaining balance of units for this particular good is 5.2 gallons. Thus, at the next stop at the “Fuel Store,” the point of sale will ask the consumer if the consumer wishes to apply the 5.2 gallons to the current purchase if the consumer presents the account 504 to the point of sale.

While FIG. 5 shows a statement that applies to both cash tracked and pre-paid unit transactions, it will be appreciated that the statement may be broken into multiple statements such as where the pre-paid unit transactions are tracked via a separate account from the cash transactions. Furthermore, it will be appreciated that for statements that combine both the cash tracked and the pre-paid unit transactions, the transaction items of the statement may be integrated rather than being presented as distinct sections.

While exemplary embodiments of the invention have been particularly shown and described, it will be understood by those skilled in the art that various other changes in the form and details may be made therein without departing from the spirit and scope of the invention.

What is claimed is:

1. A system for providing pre-paid purchases at a point of sale, comprising:
a memory that stores a current pre-pay price per unit of goods and/or services to be purchased in the future;
a communication system that queries whether a consumer wishes to pre-pay for a future purchase of a given number of units of the goods and/or services at the current pre-pay price and that receives a response to the query,; and
a database that maintains an account for the consumer by associating an account identifier to the number of units of the goods and/or services for which the consumer has pre-paid.

2. The system of claim 1, further comprising a payment system that receives a form of payment from the consumer.

3. The system of claim 2, wherein the form of payment is via a cash tracked transactional account that has the account identifier and wherein the database tracks the cash transactions of the transactional account along with the number of units for which the consumer has pre-paid.

4. The system of claim 3, further comprising a verification system for verifying that the cash tracked transactional account is being used by an authorized account holder.

5. The system of claim 3, further comprising a statement for the cash tracked account, wherein the statement specifies the cash tracked transactions in terms of monetary units and specifies the pre-paid transactions in terms of units of goods and/or services.

6. The system of claim 3, wherein upon the consumer making a purchase of the goods and/or services, the communication system queries whether the consumer wishes to use a cash tracked transaction or apply the number of units for which the consumer has pre-paid to complete the purchase.

7. The system of claim 1, further comprising a pricing system that determines the current pre-pay price per unit of goods and/or services based on a secured futures price.

8. The system of claim 7, wherein the consumer is making a purchase and wherein the pricing system determines the current pre-pay price based upon the current purchase amount.

9. The system of claim 1, wherein the goods and/or services have price volatility.

10. A computer readable medium containing instructions for providing prepaid sales of units of goods and/or services, wherein execution of the instructions performs acts comprising:
presenting an offer to a customer via an output device to pre-pay for a number of units of goods and/or services;
receiving via an input device a number of units of goods and/or services for which to pre-pay;
receiving payment from the customer for a price of the number of units of goods and/or services for which to pre-pay; and
storing the number of units of goods and/or services that have been pre-paid in a memory device in association with an identifier for the customer.

11. The computer readable medium of claim 10, wherein upon the customer presenting the identifier and attempting to purchase at least one unit of the goods and/or services, the acts further comprise:
presenting an option to the customer to apply a corresponding number of units of goods and/or services that have been pre-paid to pay for the number of units of goods and/or services that are being purchased; and
upon receiving a selection by the customer to apply the number of units of goods and/or services that have been pre-paid, then applying the corresponding number of units of goods and/or services that have been pre-paid to pay for the purchase and reducing the number of units of goods and/or services stored in memory by the corresponding number of units.

12. The computer readable medium of claim 10, wherein the customer presents a form of payment when pre-paying that is a cash tracked transactional account that has the account identifier and wherein the acts further comprise tracking the cash transactions of the transactional account along with the number of units for which the consumer has pre-paid.

13. The computer readable medium of claim 12, wherein the acts further comprise generating a statement for the cash tracked account, wherein the statement specifies the cash tracked transactions in terms of monetary units and specifies the pre-paid transactions in terms of units of goods and/or services.

14. The computer readable medium of claim 12, wherein the acts further comprise determining a current pre-pay price per unit of goods and/or services based on a secured futures price.

15. The computer readable medium of claim 14, wherein the consumer is making a purchase of goods and/or services when the offer is presented, and wherein the acts further comprise determining the current pre-pay price based upon a current purchase amount for the goods and/or services.

16. The computer readable medium of claim 10, wherein the goods and/or services have a price volatility.

17. A method of providing for pre-payment of units of goods and/or services, comprising:
detecting that the consumer is making a purchase of at least one unit of the goods and/or services after having pre-paid for at least one unit of the goods and/or services;
in response to detecting that the consumer is making the purchase after having pre-paid, presenting an offer to apply the units that have been pre-paid to pay for the purchase; and
reducing the number of units of goods and/or services being tracked as needed to pay for the purchase in response to the consumer opting to apply the units that have been pre-paid.

18. The method of claim 17, wherein in advance of detecting that the consumer is making a purchase of at least one unit of goods and/or services after having pre-paid for at least one unit of the goods and/or services, the method further comprising:
determining a current pre-paid price per unit of goods and/or services;
detecting that a consumer is making a purchase of at least one unit of the goods and/or services;
in response to detecting that the consumer is make the purchase, presenting an offer to the consumer to pre-pay for additional units of goods and/or services;
receiving a selection to pre-pay for a specified number of units of the goods and/or services;
tracking the number of units of goods and/or services purchased by the consumer;

19. The method of claim 18, wherein tracking the number of units of goods and/or services comprises maintaining the number of units of goods and/or services in relation to a cash transaction account identifier and in conjunction with a set of cash transactions where the cash transaction account has been used for payment.

20. The method of claim 19, wherein the cash transaction account is a credit card account and wherein the cash transaction account identifier is a credit card account number and wherein detecting that the consumer is making the purchase of at least one unit after having pre-paid comprises receiving the credit card account as a form of payment and detecting that a number of units of the goods and/or services have been pre-paid for the credit card account that has been received.
